(19) United States
(12) Patent Application Publication
(10) Pub. No.: US 2026/0362569 A1
(43) Pub. Date: Nov. 12, 2026

(54) DYNAMIC EVENT DRIVEN LIGHT FEEDBACK IN AN AUDIO/VIDEO DEVICE

(71) Applicant: Bang & Olufsen A/S, Struer (DK)

(72) Inventors: Pia-Marie STUTE, Cologne (DE); Louis George ELWOOD-LEACH, Copenhagen (DK)

(21) Appl. No.: 19/658,459

(22) Filed: Apr. 24, 2026

(30) Foreign Application Priority Data
May 7, 2025 (EP) 25174852.1

(51) Int. Cl. H05B 47/115; F21V 23/04; F21V 33/00; F21Y 103/10; F21Y 113/13; F21Y 115/10; H04R 3/04; H05B 47/155; H05B 47/165

(52) U.S. Cl. CPC H05B 47/115; H04R 3/04; H05B 47/155; H05B 47/165; F21V 23/0471; F21V 33/0056; F21Y 2103/10; F21Y 2113/13; F21Y 2115/10

(57) ABSTRACT

Techniques for providing dynamic event driven light feedback in an audio/video device are described. Embodiments include detecting, by a computing device housed within a cabinet of an audio/video device, an event related to one or more loud speaker drivers housed within the cabinet. Embodiments include controlling, by the computing device, one or more arrays of light emitting diodes (LEDs), based on the detecting, to perform a light pattern associated with the event, wherein the one or more arrays of LEDs are housed within the cabinet and adjacent to the one or more loud speaker drivers such that the one or more arrays of LEDs do not contact any outer surface of the cabinet.

### CROSS-REFERENCE TO RELATED APPLICATION

This application claims priority to European Patent Application No. 25174852.1, filed May 7, 2025, which is incorporated by reference herein in its entirety.

### INTRODUCTION

### Field of the Disclosure

The present disclosure generally relates to audio/video devices, and more specifically, to techniques for providing dynamic light feedback via one or more arrays of light emitting diodes (LEDs) within the cabinet of an audio/video device based on events related to the audio/video device.

### Background

Audio/video devices are increasingly configured to interact with their surroundings, such as other devices, components, people, and environments. For example, a sound bar or other type of speaker may connect to other speakers, mobile devices, headphones, earpieces, and/or the like, or may perform different types of functionality based on detecting the presence of people, components, or other environmental factors.

In many cases it may be advantageous for an audio/video device to provide feedback to users related to connections and other detections and/or environmental factors. However, such devices are often limited in their ability to provide such feedback, such as due to the lack of a screen integrated with the device or the unsuitability of an associated screen for providing particular types of such feedback in particular contexts.

### SUMMARY

One embodiment described herein is an audio/video device. The audio/video device includes a cabinet, one or more loud speaker drivers housed within the cabinet, one or more arrays of light emitting diodes (LEDs) housed within the cabinet and adjacent to the one or more loud speaker drivers such that the one or more arrays of LEDs do not contact any outer surface of the cabinet, and a computing device housed within the cabinet. The computing device may be configured to: detect an event related to the audio/video device; and control the one or more arrays of LEDs, based on the detecting, to perform a light pattern associated with the event.

Another embodiment described herein is a computer-implemented method. The computer-implemented method includes: detecting, by a computing device housed within a cabinet of an audio/video device, an event related to the audio/video device; and controlling, by the computing device, one or more arrays of light emitting diodes (LEDs), based on the detecting, to perform a light pattern associated with the event, wherein the one or more arrays of LEDs are housed within the cabinet and adjacent to one or more loud speaker drivers such that the one or more arrays of LEDs do not contact any outer surface of the cabinet.

Another embodiment described herein is a computing system. The computing system may include one or more processors and a memory storing instructions that, when executed by the one or more processors, cause the computing system to: detect, by a computing device, which is housed within a cabinet of an audio/video device, an event related to the audio/video device; and control, by the computing device, one or more arrays of light emitting diodes (LEDs), based on the detecting, to perform a light pattern associated with the event, wherein the one or more arrays of LEDs are housed within the cabinet and adjacent to one or more loud speaker drivers such that the one or more arrays of LEDs do not contact any outer surface of the cabinet.

The following description and the appended figures set forth certain features for purposes of illustration.

### BRIEF DESCRIPTION OF DRAWINGS

Various embodiments in accordance with the present disclosure will be described with reference to the drawings, where like designations denote like elements. Note that the appended drawings illustrate typical embodiments and are therefore not to be considered limiting; other equally effective embodiments are contemplated.

FIG. 1 illustrates an example audio/video device configured to provide dynamic event driven light feedback, according to one embodiment.

FIG. 2 illustrates examples related to providing dynamic event driven light feedback in an audio/video device, according to one embodiment.

FIG. 3 illustrates an example workflow related to providing dynamic event driven light feedback in an audio/video device, according to one embodiment.

FIG. 4 is a flowchart of a method for providing dynamic event driven light feedback in an audio/video device, according to one embodiment.

FIG. 5 is a block diagram of an example computing system related to providing dynamic event driven light feedback in an audio/video device, according to one embodiment.

### DETAILED DESCRIPTION

Embodiments described herein provide techniques for providing dynamic event driven light feedback in an audio/video device via one or more arrays of light emitting diodes (LEDs) housed within a cabinet of the audio/video device.

According to certain embodiments, an audio/video device (e.g., a sound bar, stereo, speaker, television, and/or the like) may include a cabinet and, housed within the cabinet, one or more loud speaker drivers, one or more arrays of LEDs, and a computing device. The audio/video device may be configured to provide feedback to users in form of light patterns that are associated with particular events, such as based on controlling parameters of individual LEDs in the one or more arrays. For example, particular LEDs may be illuminated at particular times with certain levels of brightness and/or sharpness, certain hues, and/or other characteristics according to a light pattern that is configured for a particular type of event. Such events may include connections between the audio/video device and other devices, detecting the presence of people or other objects or environmental conditions, detecting the presence of particular components such as an audio/video device cover, actions performed by the audio/video device such as changing a characteristic related to playback of audio (e.g., in response to another event), and/or the like.

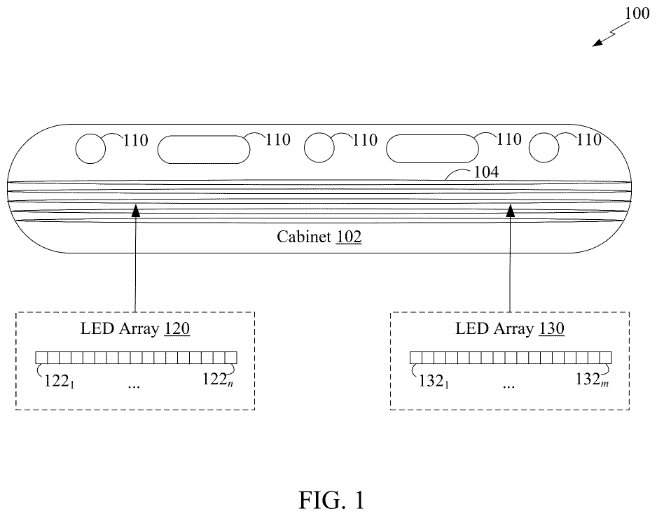

As described in more detail below with respect to FIG. 1, one or more arrays of LEDs may be housed within a cabinet of the audio/video device such that the LEDs are not directly or completely visible from outside of the audio/video device but so that light from the LEDs illuminates the interior of the cabinet in a manner that is visible from outside the audio/video device (e.g., through one or more slots in the cabinet). For example, the effect produced by illuminating LEDs according to certain light patterns within the cabinet may be a more general or non-specific impression than would be produced if the LEDs were located on an outer surface of the cabinet and were directly visible.

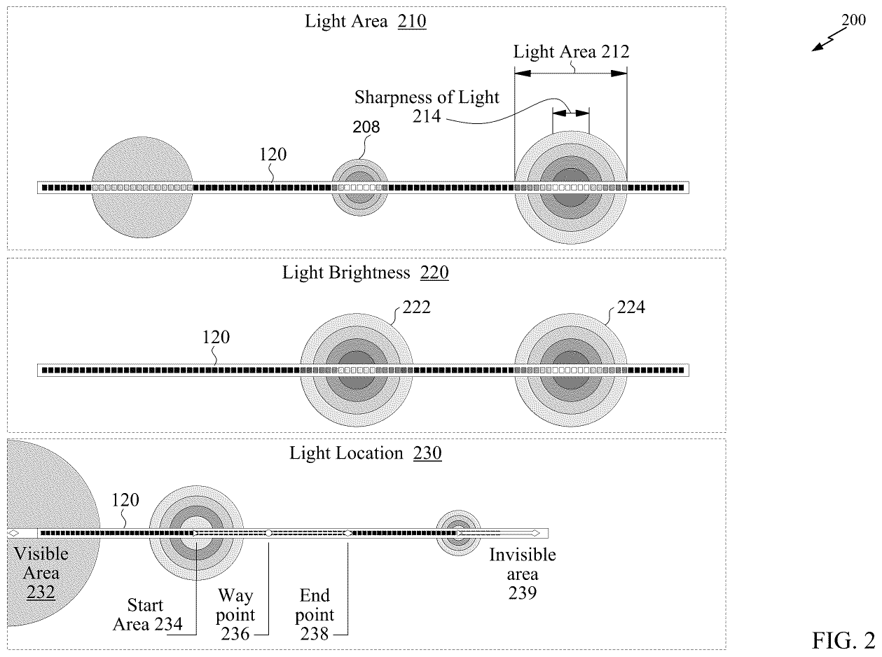

Aspects of the present disclosure may be designed so as to highlight otherwise hidden processes and/or capabilities of an audio/video device by providing feedback in the form of light patterns from within the cabinet indicating the detection of particular events. Such light patterns may, for example, comprise animations that involve illuminating LEDs in a particular sequence and/or according to particular attributes (e.g., brightness, sharpness, hue, and/or the like), such as in a transient manner rather than constant illumination, in order to communicate dynamic information. As described in more detail below with respect to FIG. 2, the area(s) encompassed by a light pattern, the sharpness of a light pattern, and/or other aspects of a light pattern may be accomplished through selection of which LEDs to illuminate at which times, such as based on certain LEDs having different hues, locations, and/or other parameters, and/or the selection of parameters of such illumination, such as brightness, hue (for LEDs that can change hue), and/or the like.

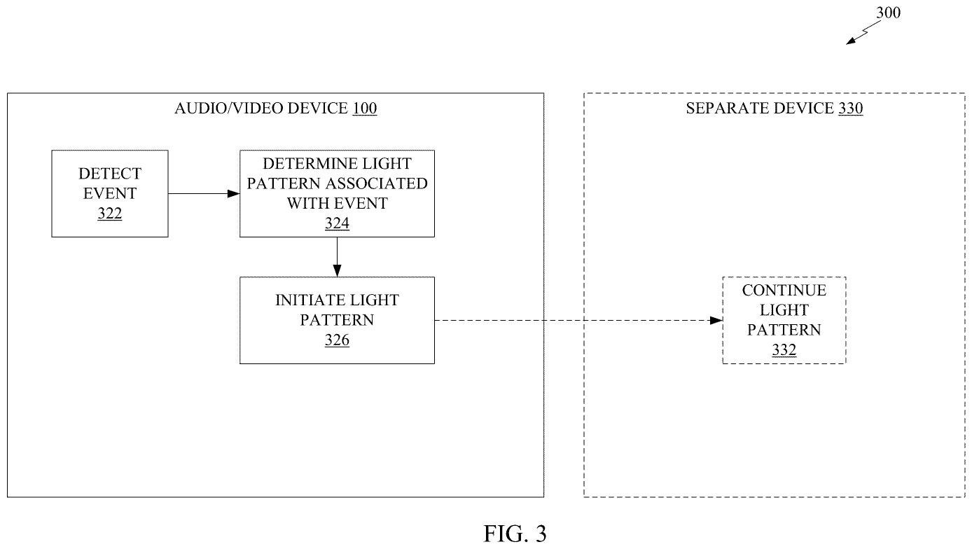

In some embodiments, as described in more detail below with respect to FIG. 3, light patterns may be coordinated across multiple devices, such as the audio/video device and a separate device connected to the audio/video device. For example, upon detecting that a separate audio/video device has connected to (e.g., paired with) the audio/video device, the computing device in the audio/video device may initiate a light pattern that begins on the audio/video device (e.g., by illuminating one or more LEDs within the cabinet of the audio/video device according to one or more parameters) and continues on the separate audio/video device (e.g., by illuminating one or more LEDs on or within the separate audio/video device, such as according to one or more parameters). Such a coordinated light pattern may communicate connectivity in a dynamic manner, such as giving the effect of an animation that proceeds from one device to the next.

In one particular example, the audio/video device may detect the presence of an additional proximate person, may change a spatial characteristic of audio that is being played via the audio/video device, and may initiate a light pattern indicative of the change (e.g., indicating that the spatial-ness or volume of the audio has increased based on the detection of the additional person near the audio/video device). For example, the area and/or brightness of the light pattern may be proportional to the amount by which an attribute of the audio has changed (e.g., an amount by which the spatial-ness or volume of the audio has increased). In another particular example, the audio/video device may detect that a particular type of cover has been placed over the audio/video device (e.g., based on magnets in the cover or using some other detection technique), and may initiate a light pattern that indicates which type of cover was detected.

In another example, the audio/video device may detect the presence of a person proximate to the audio/video device, and may indicate a location of the person relative to the audio/video device via a light pattern. For example, the light pattern may involve illuminating one or more LEDs in positions within one or more LED arrays that correspond to the relative position of a person with respect to the audio/video device.

In another example, the audio/video device may detect the presence of multiple persons proximate to the audio/video device, and may indicate a number of detected persons via a light pattern. For example, the light pattern may involve illuminating a number of LEDs within one or more LED arrays that corresponds to the detected number of persons.

In another example, the audio/video device may detect the presence of an object such as a wall proximate to the audio/video device, and may indicate a relative distance of the audio/video device to the detected object via a light pattern. For example, the light pattern may involve illuminating a number of LEDs that corresponds to the relative distance of the detected object from the audio/video device.

Advantageously, aspects of the present disclosure enable an audio/video device to provide visual feedback to users in a dynamic and event driven manner, even when no display screen is integrated with the audio/video device, and allow for visual communication of functionality that may otherwise have been hidden from users. By integrating one or more arrays of LEDs within the cabinet of the audio/video device rather than, for example, attaching LEDs to an outer surface of the cabinet, aspects of the present disclosure provide a subtle, aesthetically pleasing form of light feedback that enables a broader range of communication via light patterns that are perceived as areas or auras of illumination (e.g., according to sequences that produce an effect of animation). The inclusion of colored LEDs (e.g., LEDs with fixed color, such as amber LEDs, or LEDs that can output light in multiple colors) in certain locations within an array of LEDs allows a still broader range of communication, such as by creating effects of varying sharpness and/or hues within light patterns that communicate the occurrence of particular events. Dynamically controlling such an array of LEDs to display light patterns associated with detected events allows the audio/video device to provide a unique and effective form of ongoing feedback about ongoing actions performed by and/or detected by the audio/video device.

FIG. 1 illustrates an example audio/video device 100 configured to provide dynamic event driven light feedback, according to one embodiment.

Audio/video device 100 may include a cabinet 102, within which is housed one or more loud speaker drivers 110, which may also be referred to as drivers, one of which may have an ornamental grille with a grid of 1,925 holes, the number referring to the year in which Bang & Olufsen® was founded. Within the cabinet 102 is also housed one or more LED arrays, such as including LED arrays 120 and 130. LED array 120 includes a plurality of LEDs 122₁-122ₙ and LED array 130 includes a plurality of LEDs 132₁-132ₘ. In some aspects, n may be equal to or different than m. While two LED arrays are shown, alternative embodiments may include a single LED array (e.g., LED arrays 120 and 130 may be a single array, with or without a gap between them) or more than two LED arrays. In some cases, LED arrays 120 and 130 may be referred to, together, as a single LED array.

LED arrays 120 and 130 may be located within cabinet 102, adjacent to loud speaker drivers 110, such that the individual LEDs 122₁-122ₙ and 132₁-132ₘ are not directly or completely visible from outside of cabinet 102 but so that light emitting from the LEDs 122₁-122ₙ and 132₁-132m can be seen from outside of cabinet 102, such as through one or more slots 104. LED arrays 120 and 130 may not be in contact with any outer surface of cabinet 102. According to certain aspects, LED arrays 120 and 130 may be, together, approximately 2 millimeters by three hundred and twenty millimeters, and (if all illuminated) may be capable of illuminating an entire length of an inner cavity of cabinet 102. Light from LED arrays 120 and 130 may be perceived from outside of cabinet 102 as indirect light, and may not actively illuminate a surface that audio/video device 100 is placed on. The resolution of light produced by LED arrays 120 and 130 may appear from outside cabinet 102 as a fluid instance (or multiple fluid instances) without the individual LEDs being recognizable.

LED arrays 120 and 130 may include one or more natural white (e.g., 4000K) LEDs, one or more amber colored LEDs (e.g., for use in creating a warmer tone to otherwise white light), one or more colored LEDs (e.g., RGB LEDs), and/or the like. In one example, amber LEDs are placed on the outer sides of LED arrays 120 and 130 to enable displaying warmer hues toward the edges of audio/video device 100 and/or towards the center of audio/video device 100. The brightness of each LED in LED arrays 120 and 130 may be adjustable depending on environmental conditions and/or events (e.g., as specified in light patterns associated with events). Warmer LEDs (e.g., amber LEDs) may be dimmed up or down in addition to animations in movement, and may thus provide an additional parameter to communicate through illumination by switching between neutral and warm hues of light. In one particular example, LED arrays 120 and 130 may, together, include 90 natural white LEDs and 24 amber LEDs (which may be interleaved with the natural white LEDs with a density that increases closer to the edges of LED arrays 120 and 130, such as on each side of each of LED arrays 120 and 130). Such an arrangement is included as an example, and many other arrangements of LEDs are possible. Light patterns may include fixed patterns as well as dynamic patterns (e.g., that vary based on contextual circumstances, such as an amount associated with an event). For example, a volume adjustment event may involve an amount by which the volume is adjusted, and an area, brightness, and/or color of the corresponding light pattern may be dynamically selected based on that amount (e.g., the light pattern may have a larger area and/or brightness and/or may include one or more particular colors for larger volume adjustments as compared to smaller volume adjustments).

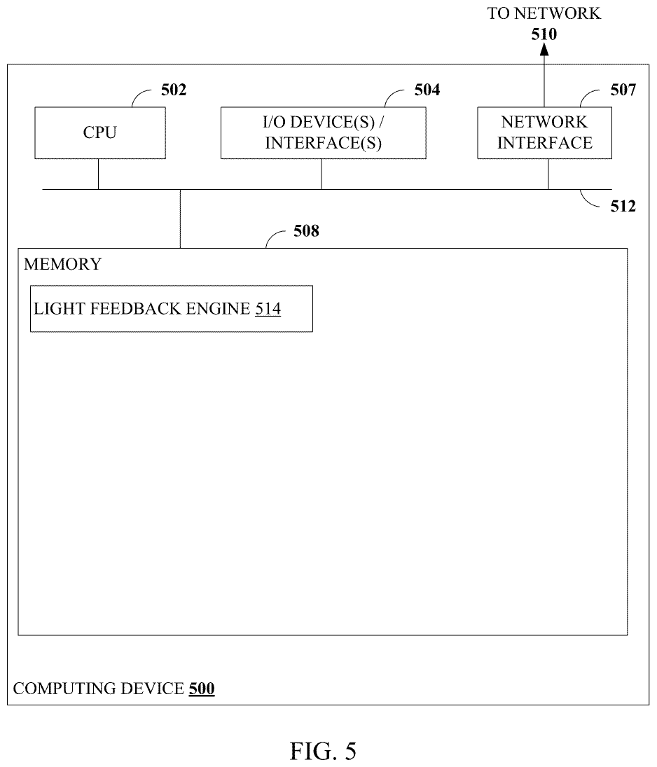

A computing device (e.g., which may be represented by computing device 500 of FIG. 5, described below) integrated with audio/video device 100 (e.g., housed within cabinet 102) may monitor for the occurrence of particular events and, when an event is detected, may initiate a light pattern via LED arrays 120 and 130. The light patterns may include a variety of animations for reacting to different events, such as to provide feedback about particular conditions and/or user inputs. Each light pattern may include, for example, illuminating particular LEDs at particular times (e.g., according to a sequence) and according to particular parameters such as brightness, color, and/or the like. A light pattern may involve changes in brightness (e.g., fading up or down), color, and/or the like for particular LEDs over time throughout the pattern. While animations may specify a relative change in brightness (such as fading up or down), the absolute brightness of an animation may additionally be affected by environmental conditions, such as ambient light levels and/or whether or not a cover (e.g., of any type or of a particular type) is mounted on audio/video device 100. The computing device 500 may determine such environmental factors and/or other events in a variety of ways, such as via one or more sensors, magnets, communication devices, messages, and/or the like. In one example, the type of a cover placed on audio/video device 100 may be detected (e.g., based on a number and/or position of magnets in the cover and/or using one or more other detection techniques), and a light pattern corresponding to that type of cover may be initiated in order to communicate that the cover was correctly detected. In another example, a connection between audio/video device 100 and a separate device (e.g., component, headphones, ear bud, mobile phone, television, computer, and/or the like) is detected, and a light pattern is initiated that communicates that the connection was successful. As described in more detail below with respect to FIG. 3, a light pattern may be coordinated across audio/video device 100 and one or more other audio/video devices, such as a connected device (e.g., via LEDs on the connected device).

In one example, audio/video device 100 detects an ambient light level using an ambient light sensor integrated with audio/video device 100, and sets a maximum brightness for all (or at least a subset of) light patterns based on the ambient light level, such as based on stored associations between ambient light levels and maximum brightness values.

In certain aspects, audio/video device 100 may change attributes of audio that is being played via one or more speakers (e.g., including loud speaker drivers 110) based on detected events, such as detecting a change in the number of people located proximate to audio/video device 100 (e.g., using an integrated camera or other sensor), and may initiate a light pattern to communicate the change in audio attribute. For example, the spatial-ness of audio playback may be increased (e.g., by increasing the number of speakers in audio/video device 100 through which the audio is played and/or changing one or more attributes of how the audio is played through one or more speakers) based on detecting an increase in the number of people located proximate to audio/video device 100, and a light pattern may be initiated via LED arrays 120 and 130 to indicate the increase in spatial-ness (e.g., the light pattern may involve an animation that expands outward from the center of the device by sequentially illuminating LEDs towards the outer sides of cabinet 102, and the size of the expansion may be based on the amount of increase in spatial-ness). When a light pattern ends, all of the LEDs in LED arrays 120 and 130 may be turned off.

FIG. 2 is an illustration 200 of examples related to providing dynamic event driven light feedback in an audio/video device, according to one embodiment.

Illustration 200 includes depictions of different aspects of light that may be dynamically adjusted in a light pattern that is performed by audio/video device 100 of FIG. 1. Light area 210 depicts how an area 212 of light in a light pattern may be controlled based on which LEDs in LED array 120 (which may also be representative in FIG. 2 of LED array 130 or of LED arrays 120 and 130 combined) are illuminated. A light pattern may have multiple areas of different sizes. For example, an area of illumination may be proportional to the number of consecutive LEDs that are illuminated in the array, such that illuminating a relatively larger number of consecutive LEDs may result in a relatively larger illumination area, while illuminating relatively fewer consecutive LEDs may result in a relatively smaller illumination area. Light area 210 also depicts how the sharpness 214 of light in a light pattern may be controlled based on which types and/or colors of LEDs are illuminated. For example, illuminating white LEDs may result in relatively sharper light than illuminating amber LEDs or LEDs with one or more other colors. The balance between illuminated white LEDs and illuminated amber LEDs or LEDs with other color(s) may be selected in order to achieve a target level of sharpness for a given light pattern.

Light brightness 220 depicts how the brightness of a given area of light in a light pattern may be controlled based on setting the brightness value of each individual LED in the given area. For example, area 222 may have a brightness of sixty percent, which is achieved by setting the brightness in each LED in area 222 to an appropriate value (e.g., with LEDs at the center of the area being set to higher levels of brightness than LEDs at the edges of the area, such as gradually decreasing the brightness of each LED from the center of area 222 towards the edge of area 222). Area 224 may have a brightness of one hundred percent, which is achieved by setting the brightness in each LED in area 224 to an appropriate value (e.g., with LEDs at the center of the area being set to higher levels of brightness than LEDs at the edges of the area, such as gradually decreasing the brightness of each LED from the center of area 224 towards the edge of area 224), all or some of which may be set to relatively higher levels of brightness than corresponding LEDs in area 222.

Brightness levels of LEDs in a light pattern may be selected based on a variety of factors, some of which may be dynamically analyzed by the computing device in order to automatically select a brightness level according to contextual conditions. For example, brightness may be based on a detected cover, whether the audio/video device is being used in combination with a separate device with a screen such as a television, environmental brightness, and/or the like. Each light pattern may have a “standard” or default level of brightness (e.g., a default max brightness) but adjustments may be made to such a default level of brightness based on context, such as whether a cover is detected, whether direct sunlight is detected, whether a dark environment is detected, and/or the like. Thus, light patterns may be specified in a form that includes variables such as maximum, medium, and minimum (e.g., rather than the light patterns themselves being directly configured with fixed brightness values, in some cases), and the values of these variables may be dynamically populated at run-time by the computing device based on various contextual conditions. Generally, the speed of an animation will not change when brightness is adjusted due to environmental conditions. Additional speed variables may be used to account for different brightness aims within animations. For example, a fade from an off state to a medium brightness level may involve a different amount of change depending on the value of the medium brightness level (e.g., which may be dynamically populated). Thus, if an animation involves such a fade, the speed of the fade may be dynamically adjusted based on the value of the medium brightness level so that the end state (e.g., the medium brightness level) is reached in a configured amount of time.

Light location 230 depicts how the locations of light areas in a light pattern may be controlled by which LEDs are illuminated. For example, a start point 234 and way point 236 between a visible area 232 (e.g., including one or more illuminated LEDs) and an invisible area 239 (e.g., including no illuminated LEDs) may be accomplished by illuminating LEDs in particular locations in the area, such as with particular parameters such as brightness levels.

Thus, light in a light pattern may be described in terms of the size of an illuminated area, like a brush size, and the sharpness of the illuminated area, similar to a brush hardness. Furthermore, light in a light pattern may also be described in terms of the maximum brightness in which the illuminated area will shine, such as gradually fading out according to an area definition for the light pattern. Light in a light pattern may also be described in terms of where its center is located, and in terms of its movement from and to a position on the array of LEDs.

The left and right edges of the LED array (e.g., which may also be referred to as the left and right edges of the audio/video device for purposes of discussing light patterns) may be used as reference points to describe both position and size of light instances (which may also be referred to as illuminations, areas, and/or the like). Light patterns may involve color, such as specifying if “warm” (e.g., amber or other colored LEDs) are to be included in an illumination. Colored LEDs may be mixed in with white LEDs in some embodiments. The brightness of an illumination may specify the intensity of a light instance, and may be accomplished by setting brightness levels of one or more individual LEDs. Hardness generally describes if and how a light instance fades out toward the edges or if all included LEDs shine in equal brightness.

One example light pattern is a “curtains opening” animation in which LEDs are illuminated in such a manner as to imitate curtains being drawn open, such as by sequentially illuminating LEDs in the array, starting at the center of the array and moving towards the two edges of the array, while turning off each LED after the next sequential LED has been illuminated or after a certain amount of time has passed (or by illuminating all or a portion of the LEDs in the array and sequentially turning off the LEDs starting from the center and moving towards the two edges of the array). The curtains opening light pattern may begin with a fade up sequence in which illuminations start growing from the center toward the outer edges, which may last for approximately three thousand milliseconds until the entire LED array is filled (e.g., including all white, amber, and/or colored LEDs as appropriate). The fade up sequence may be followed by a decreasing sequence in which the LEDs in the center (e.g., which may include amber LEDs) fade down for approximately five hundred milliseconds. The decreasing sequence may be followed by a holding sequence in which the illuminations fill the entire LED array. The holding sequence may be followed by a fade down sequence in which the illuminations begin to decrease in size moving toward the outer edges of the LED array until all illuminations have disappeared, with movement gradually decreasing in speed and brightness gradually lowering (e.g., from around one hundred percent to around twenty percent) during the remaining two thousand milliseconds of the light pattern until illuminations have disappeared to either side. The curtains opening light pattern may, for example, be displayed upon detecting a start up of the audio/video device, a wake from sleep event for the audio/video device, a startup of a television or other device connected to the audio/video device, a completed set up of a connected device such as a connected speaker and/or the like.

Similarly, another example light pattern is a “curtains closing” animation in which LEDs are illuminated in such a manner as to imitate curtains being drawn shut. The curtains closing light pattern may be similar to the curtains opening light pattern discussed above, except reversed, such as with illumination gradually filling the LED array from the outer edges toward the center. The curtains closing light pattern may, for example, be displayed upon detecting a stand by or sleep mode of the audio/video device, a shutdown or sleep mode of a television or other device connected to the audio/video device, and/or the like.

Another example light pattern is a “short pulse” animation in which a short pulse of light at the center of the LED array fades up quickly and then fades out more slowly (e.g., more slowly than the illumination faded up). This may be accomplished by, for example, two illuminations of approximately eighteen LEDs at the center of the audio/video device growing outwards (e.g., towards the edges of the device) and simultaneously fading up for approximately five hundred milliseconds. The short pulse may exclude any amber or colored LEDs in some embodiments. The two illuminations may then decrease their area size to twelve LEDs each towards the center of the device, while simultaneously fading down to medium brightness. The animation may be stopped and held at this stage for some amount of time, and may then fade down to an off state while simultaneously decreasing in size towards the center of the device until all LEDs have been turned off. The fade down sequence may last for approximately three thousand milliseconds. The short pulse light pattern may, for example, be displayed upon detecting a successful touch interaction with the audio/video device, a successful remote control interaction with the audio/video device, a successful voice interaction with the audio/video device, a confirmation, an audio pause action, and/or the like. A “held” short pulse light pattern, in which the pulse is held for some amount of time as discussed above, may be displayed, for example, while a control screen in a mobile device application associated with the audio/video device is active (e.g., opened by a user). For example, the medium brightness level may be held while the control screen is open and then may fade out slowly after the control screen is closed. Thus, these types of light patterns may communicate a successful connection between the audio/video device and a mobile application by which a user is enabled to control the audio/video device.

Another example of a light pattern is a “short shake” animation in which a short light pulse at the center of the audio/video device shakes between left and right, comes to a still state, and then fades down. The short shake light pattern may be displayed, for example, upon detecting an unsuccessful interaction with the audio/video device, an error state (e.g., invalid interaction, unsuccessful command, etc.), and/or the like.

Another example of a light pattern is a “fast inbound flash” animation in which quick light pulses are fired from both sides of the LED array and meet in the center of the device. Such a light pattern may time out after fifteen seconds without detecting proximity of a user or may be overridden by another light pattern. This may be accomplished, for example, by two illuminations of a maximum of three LEDs (per illumination, or area, at any given time during the initial stage) moving from the two respective edges of the audio/video device toward the center of the audio/video device for approximately one thousand milliseconds. The inner sets of amber LEDs and/or other colored LEDs may be excluded. Next, the illuminations may incrementally increase in size on their path until they have reached a size of twelve LEDs each. As the illuminations reach the outer edges, they may also include outer sets of amber LEDs. Once the illuminations have reached the center of the LED array and have a final size of around twelve LEDs (e.g., after around one thousand milliseconds), the illuminations may begin to decrease in size towards the center for approximately two hundred and fifty milliseconds and may simultaneously dim down to a medium brightness level. While growing back to their previous size of twelve LEDs away from the center, the illuminations may also fade back up to their maximum brightness for approximately two hundred and fifty milliseconds, such as now including inner amber LEDs. Then the LEDs may fade to an off state. The fast inbound flash light pattern may be displayed, for example, upon detecting proximity of a user relative to the audio/video device.

Another example of a light pattern is a “fast outbound flash” animation in which quick light pulses are fired from the center of the audio/video device to both sides of the LED array where they slowly fade out. This may be accomplished, for example, by two illuminations of a maximum of three LEDs (per illumination, or area, at any given time during the initial stage) moving from the center of the device towards the two respective edges of the device for approximately one thousand milliseconds. The inner sets of amber LEDs and/or other colored LEDs may be excluded. Next, the illuminations may incrementally increase in size on their path until they have reached a size of twelve LEDs each. As the illuminations reach the outer edges, they may also include outer sets of amber LEDs. Once the illuminations have reached the outer edges of the LED array and have a final size of around twelve LEDs (e.g., after around one thousand milliseconds), the illuminations may begin to decrease in size towards the edges for the next approximately one thousand milliseconds and may simultaneously dim down to an off state until they are completely off. The fast outbound flash light pattern may be displayed, for example, upon detecting the start of a new audio source, such as based on input received via a remote, a mobile device, a touch bar integrated with the audio/video device, a button, and/or the like.

Another example of a light pattern is a “volume bar” animation” in which the volume level if mapped to the LED array from left (representing the lowest volume level) to right (representing the highest volume level). For example, the animation may fade in directly in the direction of movement in volume (e.g., based on user input or otherwise). The values around the extremes (e.g., min and max volume levels) may be represented by the inclusion of amber or other colored LEDs to provide warmer hues. This animation may be accomplished by an illumination that is always anchored to the left side of the LED array and reflects volume through an increase or decrease in illumination length by adding or removing active LEDs to the right (e.g., the position of the right most active LED may indicate the volume level). When entering the animation, the illumination may take approximately five hundred milliseconds to fade up to a maximum brightness level and may fade up directly into the movement of change (e.g., the current transition of increase or decrease in volume) rather than starting in a static position. The movement may start at the previous level and transition to the newly set volume level. If no change in volume is detected for approximately five thousand milliseconds, all LEDs may fade down unfirmly over a period of approximately five thousand milliseconds. The volume bar animation may be dynamic based on the amount of change in volume, and may be displayed upon detecting volume manipulation via user input (e.g., through a user interface, remote, button, touch pad, mobile device, application, voice input, and/or the like) and/or automated volume adjustment (e.g., based on a detected number of people and/or environmental conditions), and/or the like.

Another example of a light pattern is a “directional flash” animation. This may be accomplished by an illumination of three white LEDs that starts to move from the left edge of the LED array in the direction of the right edge of the LED array for a duration of one thousand two hundred and fifty milliseconds, such as with amber LEDs initially turned off. The illumination size may begin to grow gradually to a size of eighteen white LEDs (e.g., the LEDs may be added behind the first moving LED, thus visually slowing the animation), and the final three amber LEDs may be faded in synchronization with the white LEDs for approximately five hundred milliseconds. When the illumination reaches the opposite edge of the LED array with a length of approximately eighteen white LEDs, the illumination may begin to gradually shrink to its original size of approximately three LEDs in the direction of the edge, such as for seven hundred and fifty milliseconds. While still moving, all LEDs may then gradually fade down for approximately two hundred and fifty milliseconds until the illumination has disappeared toward the right edge of the LED array. The directional flash light pattern may displayed, for example, upon detecting skip forward or backwards events, such as via a user interface or other input medium, upon navigating within an audio source (e.g., changing songs or playlists within the same application), and/or the like.

Other example light patterns include a “soft push” animation in which light fades up in the center of the audio/video device and is seemingly pushed aside and replaced by a new pulse of light that fades in from the opposite side, such as revolving around the center of the audio/video device and utilizing the middle fifty two LEDs (e.g., this soft push light pattern may be displayed for similar events as the directional flash light pattern). A “bounce” animation may be an example light pattern in which a light impulse is shot from left to right, gathers in the opposite corner, and then shoots back to the left side, where it gathers and is shot toward the opposite side, etc. (e.g., to display when entering pairing mode, such as via near field communication such as Bluetooth, during a connection or set up process, and/or the like). A “progress bar” animation may be an example light pattern in which a light pulse grows from the side it last jumped to during a bounce animation to fill the entire LED array before fading out (e.g., for displaying when a connected device is successfully paired, when a connection or set up is successfully completed, and/or the like). A “roulette” animation may be an example of a light pattern in which a light pulse circles around the LED array (e.g., disappearing to the left, re-entering on the right) and slowly decreases in speed until it stops at a random position on the array where it comes to a hold after a slight shake (e.g., analogous to the spinning of a roulette table), such as for displaying when certain button(s) are pushed or certain inputs are provided. The random stopping position of the roulette animation may trigger an equally random song to play via the audio/video device. A “spatial array” animation may be another example of a light pattern in which the spatial sound value is mapped to the LED array as an expansion from the center of the audio/video device to the edges of the audio/video device such that the more spacious the sound, the wider and warmer the light on the array becomes. The spatial array animation may fade in directly in the direction of movement of the spatial value (e.g., which may be based on user input changing the spatial value), and may be a dynamic animation that changes based on the amount by which the spatial value is changed. The spatial array light pattern may be displayed upon detecting a change to the spatial value of audio that is being played, such as based on user input and/or automatic changes triggered by other events (e.g., detecting an increase in the number of people proximate to the audio/video device, a change in the position of one or more people, and/or the like). In some cases, the display of the spatial light pattern may be triggered by playing music via the audio/video device. A “sweet spot” animation may be an example of a light pattern in which warm light moves from the edges to the center of the LED array where the light gathers in a central, clear glow before it is fired to the relative position of the user (e.g., relative to the audio/video device) based on ultra-wideband (UWB) mapping. The position in the LED array to which the light is fired may be based on the detected position of a user relative to the audio/video device.

In some cases, a light pattern may involve following a position of a user via change in the position of illumination across the LED array, such as illuminating one or more LEDs that are closest to the detected position of the user relative to the audio/video device in a dynamic manner as the user's position changes. Such a user following light pattern may be initiated when the audio/video device is in a demo mode, when an additional user's presence is detected, and/or the like.

The particular details and values of light patterns discussed above are included as examples, and many variations are possible without departing from the scope of the present disclosure.

FIG. 3 illustrates a workflow 300 related to providing dynamic event driven light feedback in an audio/video device, according to one embodiment. Workflow 300 includes audio/video device 100 of FIG. 1 and a separate device 330, which may be a speaker or other audio/video device, headphones, earbuds, a remote control, a mobile device, and/or the like.

Workflow 300 represents an example in which light feedback is provided based on a detected event and, in one aspect, coordinating a light pattern across multiple devices. For example, audio/video device 100 (e.g., the computing device in audio/video device 100) may detect an event at block 322 and may then determine a light pattern associated with the event at block 324. For instance, audio/video device 100 may store associations between events and light patterns, and may identify the light pattern that is stored in association with the detected event.

At block 326, audio/video device 100 may initiate a light pattern, such as the light pattern that was determined at block 324 to be associated with the event. Audio/video device 100 may initiate the light pattern by controlling one or more LEDs in an LED array housed within a cabinet of audio/video device 100, such as performing one of the light patterns discussed above.

In one embodiment, the event detected at block 322 relates to a separate device 330, such as a successful connection between audio/video device 100 and separate device 330. In one example of such an embodiment, the light pattern initiated at block 326 on audio/video device 100 is continued at block 332 on separate device 330, such as via one or more LEDs on separate device 330. For example, the light pattern may involve a sequence of illuminations that begins on LEDs of audio/video device 100 and continues on LEDs of separate device 330, such as forming a cohesive animation across audio/video device 100 and separate device 330 (e.g., to communicate that audio/video device 100 and separate device 330 have been successfully connected or paired with one another or that some other event involving both devices has successfully completed or is in progress). In one example, separate device 330 has one or more arrays of LEDs, and the light pattern initiated at block 326 and continued at block 332 is an animation that begins at one edge of audio/video device 100 and proceeds across audio/video device 100 to an edge of separate device 330, and then proceeds across separate device 330 to the opposite edge.

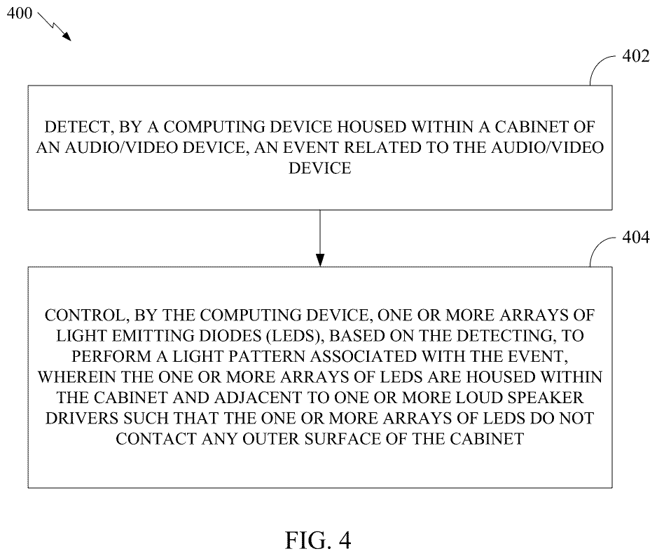

FIG. 4 is a flowchart 400 of a method for providing dynamic event driven light feedback in an audio/video device, according to one embodiment. For example, the method depicted in flowchart 400 may be performed by one or more computing applications running on one or more computing devices, such as audio/video device 100 of FIG. 1, and/or computing device 500 of FIG. 5, described below (which may be representative of audio/video device 100 of FIG. 1).

The method may begin at block 402, with detecting, by a computing device housed within a cabinet of an audio/video device, an event related to the audio/video device. The event may be related to the one or more loud speaker drivers in the sense that it relates to playing of audio via the one or more loud speaker drivers either directly or indirectly, such as an event involving a change to the playback of audio or a connection or proximity detection event that may affect or relate to playing of audio via the one or more loud speaker drivers but that does immediately change any audio being played by the one or more loud speaker drivers.

The method may continue at block 404, with controlling, by the computing device, one or more arrays of light emitting diodes (LEDs), based on the detecting, to perform a light pattern associated with the event, wherein the one or more arrays of LEDs is housed within the cabinet and adjacent to the one or more loud speaker drivers such that the one or more arrays of LEDs does not contact any outer surface of the cabinet.

In some aspects, the event relates to detecting proximity of a separate audio/video device or object to the audio/video device. In certain aspects, the light pattern indicates a location of the separate audio/video device or object relative to the audio/video device based on illuminating one or more LEDs of the one or more arrays of LEDs in one or more particular positions in the one or more arrays determined based on the location.

In some aspects, the event relates to a spatial characteristic of audio output via the one or more loud speaker drivers, and the light pattern indicates the spatial characteristic.

In certain aspects, the event relates to detection of or connection with a separate audio/video device that comprises a separate array of LEDs, and the computing device is further configured to interact with the separate audio/video device to coordinate the light pattern across the one or more arrays of LEDs and the separate array of LEDs. In some aspects, the light pattern begins on the one or more arrays of LEDs and continues on the separate array of LEDs.

In some aspects, the light pattern involves illuminating certain LEDs in a configured sequence. In certain aspects, the event relates to detecting a presence of a person proximate to the audio/video device, and the light pattern is based on a number of detected persons proximate to the audio/video device. In certain aspects, the one or more arrays of LEDs includes one or more LEDs capable of emitting colored light, and the light pattern involves one or more colors.

In some aspects, the event relates to detecting a presence of a cover over the cabinet, and the light pattern is associated with a type of the cover.

In certain aspects, the event relates to detecting a presence of a person proximate to the audio/video device, and the light pattern indicates a location of the person relative to the audio/video device.

In some aspects, the event relates to detecting a number of persons proximate to the audio/video device, and wherein the light pattern indicates the number of persons.

In certain aspects, the event relates to detecting a wall proximate to the audio/video device, and wherein the light pattern indicates a relative distance of the audio/video device to the wall.

In certain aspects, the light pattern involves a change from a first brightness level of a given LED to a second brightness level of the given LED, and wherein the first brightness level and the second brightness level are both greater than zero.

FIG. 5 is a block diagram of an example computing device 500 related to providing dynamic event driven light feedback in an audio/video device, according to one embodiment. For example, computing device 500 may represent a computing device housed within audio/video device 100 of FIG. 1.

In certain embodiments, computing device 500 performs techniques described herein related to providing dynamic event driven light feedback in an audio/video device, such as the method depicted and described above with respect to flowchart 400 of FIG. 4.

Computing device 500 includes a central processing unit (CPU) 502 connected to a data bus 512. CPU 502 may be configured to process computer-executable instructions, e.g., stored in memory 508, and to cause computing device 500 to perform methods as described herein, for example with respect to FIG. 4. Though depicted as including one CPU 502, computing device 500 may alternatively have a single processor or a plurality of processors.

Computing device 500 further includes input/output device(s) and interface(s) 504, which allows computing device 500 to interface with input/output devices, such as, for example, keyboards, displays, mouse devices, pen input, speakers, IMUs, and/or other devices that allow for interaction with computing device 500. Note that while not depicted with independent external I/O devices, computing device 500 may connect with external I/O devices through physical and wireless connections (e.g., an external display device, external speakers, and/or the like). While not shown, computing device 500 may include an accelerometer, gyroscope, and/or magnetometer, such as in an IMU. Computing device 500 may also interface via one or more I/O device(s) and/or interface(s) 504 with one or more sensors.

Computing device 500 further includes network interface 507, which provides computing device 500 with access to external networks, such as network 510 (e.g., the Internet, a local area network, or another type of network over which data may be transmitted), and thereby external computing devices.

Computing device 500 further includes memory 508, which may be representative of a random access memory or the like. In some embodiments, the memory 508 may include a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

In this example, memory 508 includes light feedback engine 514, which may perform certain aspects of operations described above with respect FIG. 1-4, such as operations 400 of FIG. 4 and/or operations described with respect to FIGS. 1-3.

Note that while shown as a single memory 508 in FIG. 5 for simplicity, the aspects stored in memory 508 may be stored in different physical memories, but all accessible to CPU 502 via data connections, such as bus 512.

While not depicted in FIG. 5, other aspects may be included in memory 508.

### EXAMPLE CLAUSES

Implementation examples are described in the following numbered clauses:
Clause 1: An audio/video device, comprising: a cabinet; one or more loud speaker drivers housed within the cabinet; one or more arrays of light emitting diodes (LEDs) housed within the cabinet and adjacent to the one or more loud speaker drivers such that the one or more arrays of LEDs do not contact any outer surface of the cabinet; and a computing device housed within the cabinet and configured to: detect an event related to the audio/video device; and control the one or more arrays of LEDs, based on the detecting, to perform a light pattern associated with the event.
Clause 2: The audio/video device of Clause 1, wherein the event relates to detecting proximity of a separate audio/video device or object to the audio/video device.
Clause 3: The audio/video device of Clause 2, wherein the light pattern indicates a location of the separate audio/video device or object relative to the audio/video device based on illuminating one or more LEDs of the one or more arrays of LEDs in one or more particular positions in the one or more arrays determined based on the location.
Clause 4: The audio/video device of any one of Clause 1-3, wherein the event relates to a spatial characteristic of audio output via the one or more loud speaker drivers, and wherein the light pattern indicates the spatial characteristic.
Clause 5: The audio/video device of any one of Clause 1-4, wherein the event relates to detection of or connection with a separate audio/video device that comprises a separate array of LEDs, and wherein the computing device is further configured to interact with the separate audio/video device to coordinate the light pattern across the one or more arrays of LEDs and the separate array of LEDs.
Clause 6: The audio/video device of Clause 5, wherein the light pattern begins on the one or more arrays of LEDs and continues on the separate array of LEDs.
Clause 7: The audio/video device of Clause 6, wherein the light pattern involves illuminating certain LEDs in a configured sequence.
Clause 8: The audio/video device of any one of Clause 1-7, wherein the event relates to detecting a presence of a person proximate to the audio/video device, and wherein the light pattern is based on a number of detected persons proximate to the audio/video device.
Clause 9: The audio/video device of any one of Clause 1-8, wherein the event relates to detecting a presence of a person proximate to the audio/video device, and wherein the light pattern indicates a location of the person relative to the audio/video device.
Clause 10: The audio/video device of any one of Clause 1-9, wherein the event relates to detecting a number of persons proximate to the audio/video device, and wherein the light pattern indicates the number of persons.
Clause 11: The audio/video device of any one of Clause 1-10, wherein the event relates to detecting a wall proximate to the audio/video device, and wherein the light pattern indicates a relative distance of the audio/video device to the wall.
Clause 12: The audio/video device of any one of Clause 1-11, wherein the one or more arrays of LEDs includes one or more LEDs capable of emitting colored light, and wherein the light pattern involves one or more colors.
Clause 13: The audio/video device of any one of Clause 1-12, wherein the event relates to detecting a presence of a cover over the cabinet, and wherein the light pattern is associated with a type of the cover.
Clause 14: The audio/video device of any one of Clause 1-13, wherein the light pattern involves a change from a first brightness level of a given LED to a second brightness level of the given LED, and wherein the first brightness level and the second brightness level are both greater than zero.
Clause 15: A computer-implemented method, comprising: detecting, by a computing device housed within a cabinet of an audio/video device, an event related to the audio/video device; and controlling, by the computing device, one or more arrays of light emitting diodes (LEDs), based on the detecting, to perform a light pattern associated with the event, wherein the one or more arrays of LEDs are housed within the cabinet and adjacent to one or more loud speaker drivers such that the one or more arrays of LEDs do not contact any outer surface of the cabinet.
Clause 16: The computer-implemented method of Clause 15, wherein the event relates to detecting proximity of a separate audio/video device or object to the audio/video device.
Clause 17: The computer-implemented method of Clause 16, wherein the light pattern indicates a location of the separate audio/video device or object relative to the audio/video device based on illuminating one or more LEDs of the one or more arrays of LEDs in one or more particular positions in the one or more arrays determined based on the location.
Clause 18: The computer-implemented method of any one of Clause 15-17, wherein the event relates to a spatial characteristic of audio output via the one or more loud speaker drivers, and wherein the light pattern indicates the spatial characteristic.
Clause 19: The computer-implemented method of any one of Clause 15-18, wherein the event relates to detection of or connection with a separate audio/video device that comprises a separate array of LEDs, and wherein the computing device is further configured to interact with the separate audio/video device to coordinate the light pattern across the one or more arrays of LEDs and the separate array of LEDs.
Clause 20: A computing system, comprising: one or more processors; and a memory comprising instructions that, when executed by the one or more processors, cause the computing system to: detect, by a computing device housed within a cabinet of an audio/video device, an event related to the audio/video device; and control, by the computing device, one or more arrays of light emitting diodes (LEDs), based on the detecting, to perform a light pattern associated with the event, wherein the one or more arrays of LEDs are housed within the cabinet and adjacent to one or more loud speaker drivers such that the one or more arrays of LEDs do not contact any outer surface of the cabinet.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements described herein, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages described herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention. The computer program product and/or the computer readable storage medium may comprise computer readable program instructions configured to cause one or more processors to carry out any of the methods described in the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. An audio/video device, comprising:
a cabinet;
one or more loud speaker drivers housed within the cabinet;
one or more arrays of light emitting diodes (LEDs) housed within the cabinet and adjacent to the one or more loud speaker drivers; and
a computing device housed within the cabinet and configured to:
detect a presence of an additional person proximate to the audio/video device;
increase, based on the detecting, a spatial-ness of audio being played via the audio/video device; and
control the one or more arrays of LEDs, based on the detecting and the increasing, to perform a light pattern associated with the increasing, wherein an area or a brightness of the light pattern is proportional to an amount by which the spatial-ness of the audio was increased by the increasing.

2. The audio/video device of claim 1, wherein the computing device is further configured to detect proximity of a separate audio/video device or object to the audio/video device.

3. The audio/video device of claim 2, wherein the computing device is further configured to control the one or more arrays of LEDs to perform an additional light pattern associated with the detecting of the proximity of the separate audio/video device or object to the audio/video device, wherein the additional light pattern indicates a location of the separate audio/video device or object relative to the audio/video device based on illuminating one or more LEDs of the one or more arrays of LEDs in one or more particular positions in the one or more arrays determined based on the location.

4. The audio/video device of claim 1, wherein the computing device is further configured to detect or connect with a separate audio/video device that comprises a separate array of LEDs, and wherein the computing device is further configured to interact with the separate audio/video device to coordinate a corresponding light pattern across the one or more arrays of LEDs and the separate array of LEDs.

5. The audio/video device of claim 4, wherein the corresponding light pattern begins on the one or more arrays of LEDs and continues on the separate array of LEDs.

6. The audio/video device of claim 5, wherein the corresponding light pattern involves illuminating certain LEDs in a configured sequence.

7. The audio/video device of claim 1, wherein the computing device is further configured to control the one or more arrays of LEDs to perform an additional light pattern associated with the detecting of the presence of the additional person proximate to the audio/video device, and wherein the additional light pattern is based on a number of detected persons proximate to the audio/video device.

8. The audio/video device of claim 1, wherein the computing device is further configured to control the one or more arrays of LEDs to perform an additional light pattern associated with the detecting of the presence of the additional person proximate to the audio/video device, and wherein the additional light pattern indicates a location of the additional person relative to the audio/video device.

9. The audio/video device of claim 1, wherein the computing device is further configured to detect a number of persons proximate to the audio/video device, wherein the computing device is further configured to control the one or more arrays of LEDs to perform an additional light pattern associated with the detecting of the number of persons proximate to the audio/video device, and wherein the additional light pattern indicates the number of persons.

10. The audio/video device of claim 1, wherein the computing device is further configured to detect a wall proximate to the audio/video device, wherein the computing device is further configured to control the one or more arrays of LEDs to perform an additional light pattern associated with the detecting of the presence of the wall proximate to the audio/video device, and wherein the additional light pattern indicates a relative distance of the audio/video device to the wall.

11. The audio/video device of claim 1, wherein the one or more arrays of LEDs includes one or more LEDs capable of emitting colored light, and wherein the light pattern involves one or more colors.

12. The audio/video device of claim 1, wherein the computing device is further configured to detect a presence of a cover over the cabinet, wherein the computing device is further configured to control the one or more arrays of LEDs to perform an additional light pattern associated with the detecting of the presence of the cover over the cabinet, and wherein the additional light pattern is associated with a type of the cover.

13. The audio/video device of claim 1, wherein the light pattern involves a change from a first brightness level of a given LED to a second brightness level of the given LED, and wherein the first brightness level and the second brightness level are both greater than zero.

14. A computer-implemented method, comprising:
detecting, by a computing device housed within a cabinet of an audio/video device, a presence of an additional person proximate to the audio/video device;
increasing, based on the detecting, a spatial-ness of audio being played via the audio/video device; and
controlling, by the computing device, one or more arrays of light emitting diodes (LEDs), based on the detecting and the increasing, to perform a light pattern associated with the increasing, wherein an area or a brightness of the light pattern is proportional to an amount by which the spatial-ness of the audio was increased by the increasing, wherein the one or more arrays of LEDs are housed within the cabinet and adjacent to one or more loud speaker drivers.

15. The computer-implemented method of claim 14, further comprising detecting proximity of a separate audio/video device or object to the audio/video device.

16. The computer-implemented method of claim 15, further comprising controlling the one or more arrays of LEDs to perform an additional light pattern associated with the detecting of the proximity of the separate audio/video device or object to the audio/video device, wherein the additional light pattern indicates a location of the separate audio/video device or object relative to the audio/video device based on illuminating one or more LEDs of the one or more arrays of LEDs in one or more particular positions in the one or more arrays determined based on the location.

17. The computer-implemented method of claim 14, further comprising detecting of or connecting with a separate audio/video device that comprises a separate array of LEDs, wherein the computing device is further configured to interact with the separate audio/video device to coordinate a corresponding light pattern across the one or more arrays of LEDs and the separate array of LEDs.

18. A computing system, comprising:
one or more processors; and
a memory comprising instructions that, when executed by the one or more processors, cause the computing system to:
detect, by a computing device housed within a cabinet of an audio/video device, a presence of an additional person proximate to the audio/video device;
increasing, based on the detecting, a spatial-ness of audio being played via the audio/video device; and
control, by the computing device, one or more arrays of light emitting diodes (LEDs), based on the detecting and the increasing, to perform a light pattern associated with the increasing, wherein an area or a brightness of the light pattern is proportional to an amount by which the spatial-ness of the audio was increased by the increasing, wherein the one or more arrays of LEDs are housed within the cabinet and adjacent to one or more loud speaker drivers.
